(19) United States
(12) Patent Application Publication
(10) Pub. No.: US 2017/0370439 A1
(43) Pub. Date: Dec. 28, 2017

(54) COUNTERFEIT REFRIGERANT ANALYZER

(71) Applicants: Jure REBERNIK, Sencur (SI); Branimir STOJKO, Sencur (SI); Matej KOSIR, Trzic (SI); Peter HEBERLE, Radovljica (SI); VEYANCE TECHNOLOGIES, INC., Fairlawn, OH (US)

(72) Inventors: Ivan Rydkin, Rochester, NY (US); Warren Clough, Cicero, NY (US); Zhongfen Ding, South Windsor, CT (US); Lei Chen, South Windsor, CT (US)

(73) Assignee: Carrier Corporation, Jupiter, FL (US)

(21) Appl. No.: 15/539,593

(22) PCT Filed: Dec. 9, 2015
(86) PCT No.: PCT/US2015/064818

§ 371 Date: Jun. 23, 2017

Related U.S. Application Data
(60) Provisional application No. 62/096,220, filed on Dec. 23, 2014.

(51) Int. Cl. F16F 9/05

(52) U.S. Cl. CPC F16F 9/05

(57) ABSTRACT

The present invention is directed to an air spring having a flexible member which collapses into the form of a double meniscus under conditions where there is a substantial or a complete loss of air pressure. The double meniscus prevents the flexible member from rolling over the piston and/or chafing against surrounding parts of the vehicle on which the air spring is mounted. This is accomplished by incorporating a flexible member having a top portion, a bottom portion, and an expansion region between the top portion and the bottom portion of the flexible member, wherein the top portion is at least 10% larger in diameter than the bottom portion of the flexible member. The present invention more specifically discloses an air spring comprising a piston, a top plate, and a flexible member which is affixed to the piston and the top plate, wherein the piston, the top plate and the flexible member defines a pressurizable chamber, wherein the flexible member is comprised of a top portion, a bottom portion, and an expansion region extending between the top portion and the bottom portion of the flexible member, wherein the top portion has a diameter which is at least 10% larger than the diameter of the bottom portion.

### FIELD OF THE INVENTION

The present invention is in the field of air springs. More specifically this invention relates to air springs for use on a wide variety of commercial, private, industrial, mining, and agricultural vehicles.

### BACKGROUND OF THE INVENTION

Air springs have been used as a component of a wide variety of motor vehicles and various other machines and equipment for many years. They are utilized to provide cushioning between movable parts and are primarily employed to absorb shock loads imparted thereon. A typical air spring consists of at least one flexible elastomeric reinforced sleeve extending between a pair of retainers, forming a pressurized chamber therein. The sleeve typically has a relatively inextensible bead core at each end for securing the sleeve to the retainers. Alternatively, the sleeve may be secured to the retainers by conventional crimping means. There may be one or more pistons associated with the air spring. The fluid in the pressurized chamber, generally air, absorbs most of the shock impressed upon or experienced by one of retainers. The retainers move towards and away from each other when the air spring is subjected to forces.

Both upper and lower retainers are conventionally formed of stamped metal. However, the upper and lower retainers can also be made utilizing polymeric materials such as fiberglass reinforced nylon. If the air spring has a piston, the piston, upon which the lower retainer is secured, may be metal, thermoplastic, or a fiber filled thermoplastic. A bumper, mounted on either retainer and provided for impact absorption and transference, is typically comprised of a cured elastomeric material or a thermoplastic elastomer. The exact choice of material is contingent upon the forces which will ultimately be acting on the air spring and the forces to which the bumper will be subjected as well as other considerations. In any case, the bumper helps to protect the air spring from damage in cases where air pressure is lost by absorbing impact between the piston and the top plate.

U.S. Pat. No. 4,784,376 discloses an improved air spring including: a pair of end members adapted to be mounted at spaced locations; a flexible sleeve formed of an elastomeric material containing reinforcing cords and having open ends sealingly engaged with the end members forming a pressurized fluid chamber therebetween; one of said end members having an end cap extending within one of the open ends of the sleeve and a clamp ring extending about said one sleeve end in clamped engagement with said end cap compressing the sleeve material therebetween; and an annular curved axially extending projection formed on a mating surface of the clamp ring extending into a concave recess formed in a mating surface of the end cap placing the sleeve in compression shear throughout radially spaced annular areas on opposite sides of said projection, and an intervening area within said recess between said annular compressive shear areas having a greater separation than the thickness of the sleeve material to permit the sleeve material to expand therein.

U.S. Pat. No. 6,926,264 discloses an air spring for absorbing and transmitting shock loads between parts moveable relative to one another, the air spring comprising a flexible cylindrical sleeve which is secured at each end to form a fluid chamber therein, a piston, the sleeve being secured at one end to a retainer and being secured at the opposing end by the piston, the air spring being characterized by: the retainer being integrally formed with an intermediate ribbed reinforcement structure to strengthen the retainer, allowing for direct mounting of the air spring to one of the moveable parts, the intermediate ribbed reinforcement structure of the retainer comprising an outer plate and an inner plate which are parallel to each other, and a plurality of ribs that extend between the outer plate and the inner plate.

U.S. Pat. No. 7,681,868 discloses an air spring comprising: a roll-off piston; a rolling-lobe flexible member made of rubber or elastomeric material; said rolling-lobe flexible member having a first opening lying opposite said roll-off piston and a second opening assigned to said roll-off piston; an attachment part configured as a head plate; said attachment part being made of thermoplastic or thermoset plastic and having air connection means formed integrally therewith; said attachment part having an outer rim and a conical region also formed integrally therewith; said outer rim and conical region facing toward said rolling-lobe flexible member; said attachment part defining a vulcanization region extending from the side of said rim facing toward said rolling-lobe flexible member into said conical region; and, said rolling-lobe flexible member being tightly vulcanized to said attachment part in said vulcanization region at said first opening while said rolling-lobe flexible member is seated in said vulcanization region.

Some air spring kinematics have a very short pivot arm, and in such air springs, the piston is angled and has a large offset against the bead plate. In conventional air springs, where there is a substantial drop or a complete loss of air pressure, the flexible member can become damaged by rolling over the piston of the air spring or coming into contact with surrounding parts of the chasse of the vehicle on which the air spring is mounted, such as a break cylinder, piston bracket, or the like. When this occurs, the flexible member can become chaffed, punctured, torn or otherwise damaged.

### SUMMARY OF THE INVENTION

The present invention is directed to an air spring having a flexible member which collapses into the form of a double meniscus under conditions where there is a substantial or a complete loss of air pressure. The double meniscus prevents the flexible member from rolling over the piston and/or chafing against surrounding parts of the vehicle on which the air spring is mounted. This is accomplished by incorporating a flexible member having a top portion, a bottom portion, and an expansion region between the top portion and the bottom portion of the flexible member, wherein the top portion is at least 10% larger in diameter than the bottom portion of the flexible member.

The present invention more specifically discloses an air spring comprising a piston, a top plate, and a flexible member which is affixed to the piston and the top plate, wherein the piston, the top plate and the flexible member defines a pressurizable chamber, wherein the flexible member is comprised of a top portion, a bottom portion, and an expansion region extending between the top portion and the bottom portion of the flexible member, wherein the top portion has a diameter which is at least 10% larger than the diameter of the bottom portion.

### BRIEF DESCRIPTION OF THE DRAWINGS

FIG. 1 illustrates an air spring of this invention in its fully extended state.

FIG. 2 illustrates an air spring of this invention in a compacted state as might be experienced after air loss which shows the flexible member of the air spring in the configuration of a double meniscus.

FIG. 3 illustrates an air spring of this invention in a compacted state wherein the piston of the air spring is at an offset angle relative to the bead plate of the air spring.

### DETAILED DESCRIPTION OF THE INVENTION

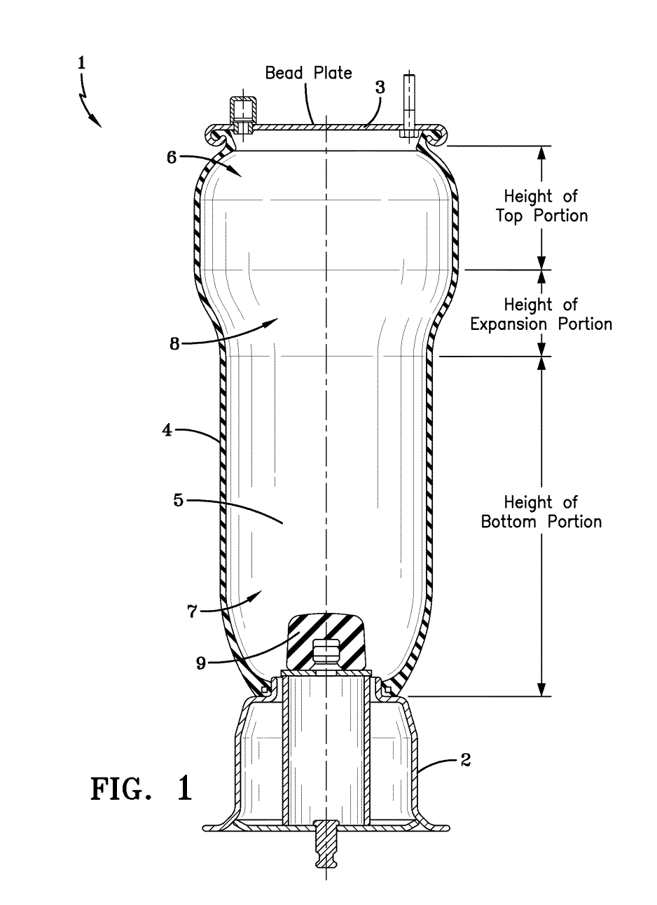

The air spring 1 of this invention includes a piston 2, a top plate 3, and a flexible member 4 which is affixed to the piston 2 and the top plate 3 as shown in FIG. 1. The piston 2, the top plate 3, and the flexible member 4 define a pressurizable chamber 5. The flexible member 4 is typically made of a cured rubber which can be reinforced with one or more layers of fabric reinforcement. The pressurizable chamber 5 is generally filled with a gas, such as air or nitrogen, to a pressure greater than atmospheric pressure. The gas is usually air for economic reasons. However, the pressurizable chamber can optionally be filled with an inert gas, such as nitrogen to help protect the flexible member (a rubber component) from degradation caused by oxygen or ozone.

The flexible member 4 is comprised of a top portion 6, a bottom portion 7, and an expansion region 8 extending between the top portion 6 and the bottom portion 7 of the flexible member 4. The top portion 6 has a diameter which is at least 10% larger than the diameter of the bottom portion 7. For instance, the in top portion can have a diameter which is 10% to 40% larger than the diameter of the bottom portion 7. In one embodiment of this invention the top portion 6 can have a diameter which is in the range 12% to 40% larger than the diameter of the bottom portion 7. The top portion 6 will frequently have a diameter which is in the range 14% to 25% larger than the diameter of the bottom portion 7. For instance, the top portion 6 can have a diameter which is in the range 15% to 20% larger than the diameter of the bottom portion 7.

The bottom portion 7 of the flexible member 4 typically represents from about 20% to about 80% of the total height of the flexible member 4 in its fully extended state as illustrated in FIG. 1. In one embodiment of this invention the bottom portion 7 of the flexible member 4 normally represents from about 50% to about 85% of the total height of the flexible member 4 in its fully extended state as illustrated in FIG. 1. For instance, the bottom portion 7 of the flexible member 4 typically represents from about 55% to about 65% of the total height of the flexible member 4 in its fully extended state as illustrated in FIG. 1.

The top portion 6 of the flexible member 4 typically represents from about 10% to about 60% of the total height of the flexible member 4 in its fully extended state. The top portion 6 of the flexible member 4 normally represents from about 20% to about 40% of the total height of the flexible member 4 in its fully extended state. The top portion 6 of the flexible member 4 generally represents from about 25% to about 35% of the total height of the flexible member 4 in its fully extended state.

The expansion region 8 typically represents about 4% to about 30% of the total height of the flexible member 4 in its fully extended state. The expansion region 8 normally represents about 6% to about 10% of the total height of the flexible member 4 in its fully extended state. The expansion region 8 generally represents about 7% to about 9% of the total height of the flexible member 4 in its fully extended state. It should be noted that the total height of the flexible member is the sum of the height of the top portion 6, the height of the expansion region 8, and the height of the bottom portion 7 of the flexible member.

The air spring 1 will typically also include a bumper 9 which is affixed to the piston 2 and which extends into the pressurized chamber 5. Alternatively, the bumper 9 can be attached to top plate 3. The bumper 9 is typically made of a cure elastomer or a thermoplastic elastomer.

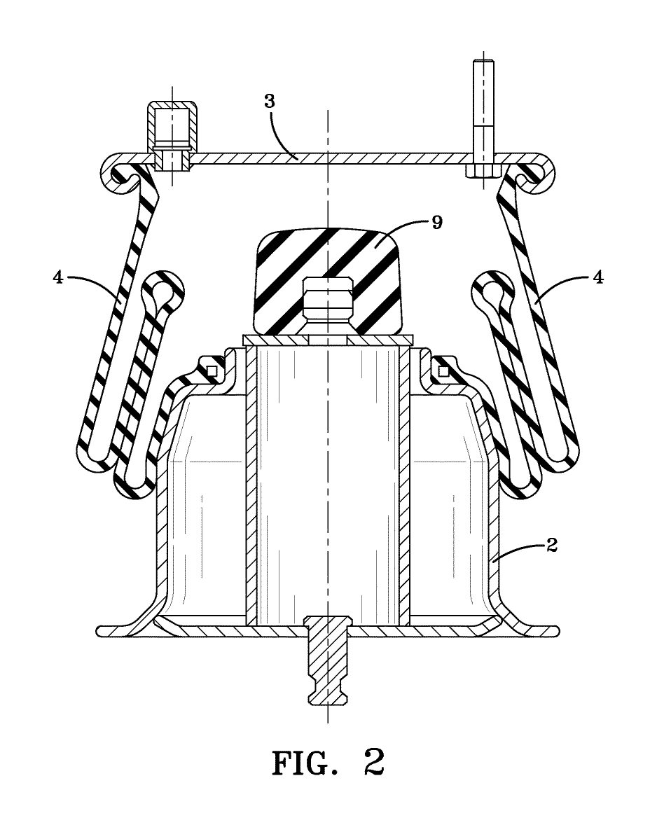

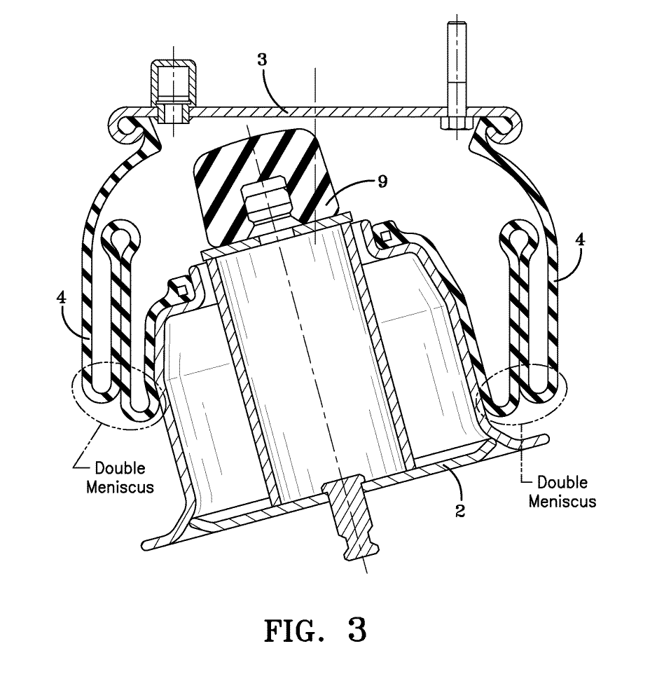

As illustrates in FIG. 2 the flexible member 4 folds two times to compact into the configuration of a double meniscus as it is compressed, such as under the condition of partial or complete air loss. FIG. 3 illustrates the flexible member 4 folded two times and compacted into the configuration of a double meniscus as it is compressed wherein the piston 2 of the air spring is at an offset angle relative to the bead plate 3 of the air spring 1.

In one embodiment of this invention the air spring 1 includes a composite bead plate 3 as described in U.S. patent application Ser. No. 14/200,150. The teachings of U.S. patent application Ser. No. 14/200,150 are incorporated herein by reference. In another embodiment of this invention the air spring 1 can include an air spring upper retained as described in U.S. Pat. No. 6,926,264 B1. The teachings of U.S. Pat. No. 6,926,262 B1 are also incorporated herein by reference in their entirety.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. An air spring comprising a piston, a top plate, and a flexible member which is affixed to the piston and the top plate, wherein the piston, the top plate and the flexible member defines a pressurizable chamber, wherein the flexible member comprises a top portion, a bottom portion, and an expansion region extending between the top portion and the bottom portion of the flexible member, wherein the top portion has a diameter which is at least 10% larger than the diameter of the bottom portion.

2. The air spring of claim 1 wherein the top portion has a diameter which is within the range of 12% to 40% larger than the diameter of the bottom portion.

3. The air spring of claim 1 wherein the bottom portion of the flexible member represents from about 20% to about 80% of the total height of the flexible member in its fully extended state.

4. The air spring of claim 3 wherein the top portion of the flexible member represents from about 10% to about 60% of the total height of the flexible member in its fully extended state.

5. The air spring of claim 4 wherein the expansion region represents about 4% to about 30% of the total height of the flexible member in its fully extended state.

6. The air spring as specified in claim 1 which is further comprised of a bumper which is affixed to the piston and which extends into the pressurized chamber.

7. The air spring of claim 1 wherein the top portion has a diameter which is within the range of 14% to 25% larger than the diameter of the bottom portion.

8. The air spring of claim 1 wherein the top portion has a diameter which is within the range of 15% to 20% larger than the diameter of the bottom portion.

9. The air spring of claim 1 wherein the bottom portion of the flexible member represents from about 50% to about 85% of the total height of the flexible member in its fully extended state.

10. The air spring of claim 1 wherein the bottom portion of the flexible member represents from about 55% to about 65% of the total height of the flexible member in its fully extended state.

11. The air spring of claim 4 wherein the expansion region represents about 6% to about 10% of the total height of the flexible member in its fully extended state.

12. The air spring of claim 4 wherein the expansion region represents about 7% to about 9% of the total height of the flexible member in its fully extended state.
